(19) United States
(12) Patent Application Publication
(10) Pub. No.: US 2017/0120841 A1
(43) Pub. Date: May 4, 2017

(54) Rear View Camera System

(71) Applicant: Terry Knoblock, Mexico, NY (US)

(72) Inventor: Terry Knoblock, Mexico, NY (US)

(21) Appl. No.: 14/927,219

(22) Filed: Oct. 29, 2015

(51) Int. Cl. B60R 11/04; H04N 5/232; G06K 9/00; H04N 5/225

(52) U.S. Cl. CPC B60R 11/04; H04N 5/2252; H04N 5/2254; H04N 5/23293; G06K 9/00791; B60R 2300/202; B60R 2300/105; B60R 2300/802

(57) ABSTRACT

A rear view camera system includes a vehicle that has an ignition. The vehicle has a first lateral side, a second lateral side and a back side. A pair of cameras is provided and each of the cameras is coupled to the vehicle. Each of the cameras is positioned on an associated one of the first lateral side and the second lateral side. Each of the cameras is oriented to face the back side. Thus, each of the cameras may monitor an associated one of a pair of blind spots with respect to the vehicle. A monitor is positioned within the vehicle and the monitor may be observed while the vehicle is being driven. The monitor is in communication with each of the cameras. Thus, the monitor may display each of the pair of blind spots thereby enhancing safe operation of the vehicle.

### BACKGROUND OF THE DISCLOSURE

### Field of the Disclosure

The disclosure relates to camera devices and more particularly pertains to a new camera device for increasing visibility of a blind spot with respect to a vehicle.

### SUMMARY OF THE DISCLOSURE

An embodiment of the disclosure meets the needs presented above by generally comprising a vehicle that has an ignition. The vehicle has a first lateral side, a second lateral side and a back side. A pair of cameras is provided and each of the cameras is coupled to the vehicle. Each of the cameras is positioned on an associated one of the first lateral side and the second lateral side. Each of the cameras is oriented to face the back side. Thus, each of the cameras may monitor an associated one of a pair of blind spots with respect to the vehicle. A monitor is positioned within the vehicle and the monitor may be observed while the vehicle is being driven. The monitor is in communication with each of the cameras. Thus, the monitor may display each of the pair of blind spots thereby enhancing safe operation of the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective kit view of a rear view camera system according to an embodiment of the disclosure.

FIG. 2 is a bottom view of an embodiment of the disclosure.

FIG. 3 is a front view of an embodiment of the disclosure.

FIG. 4 is a perspective in-use view of an embodiment of the disclosure.

FIG. 5 is a front view of an alternative embodiment of the disclosure.

FIG. 6 is a right side view of an alternative embodiment of the disclosure.

FIG. 7 is a schematic view of an embodiment of the disclosure.

### DESCRIPTION OF THE PREFERRED EMBODIMENT

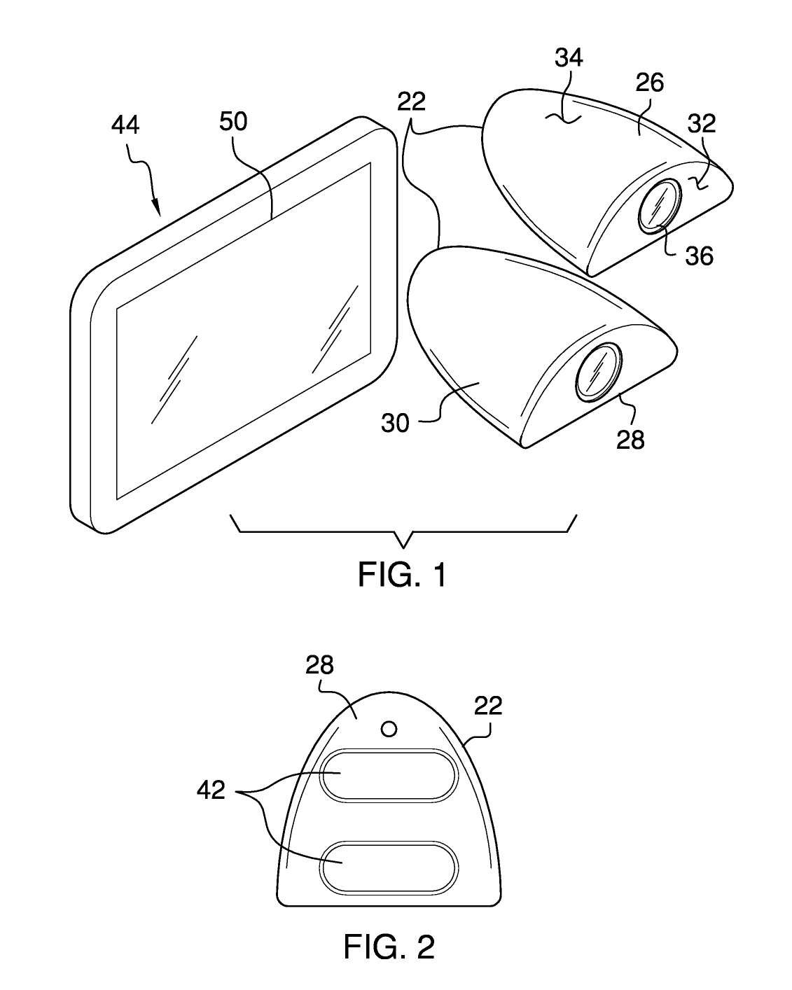

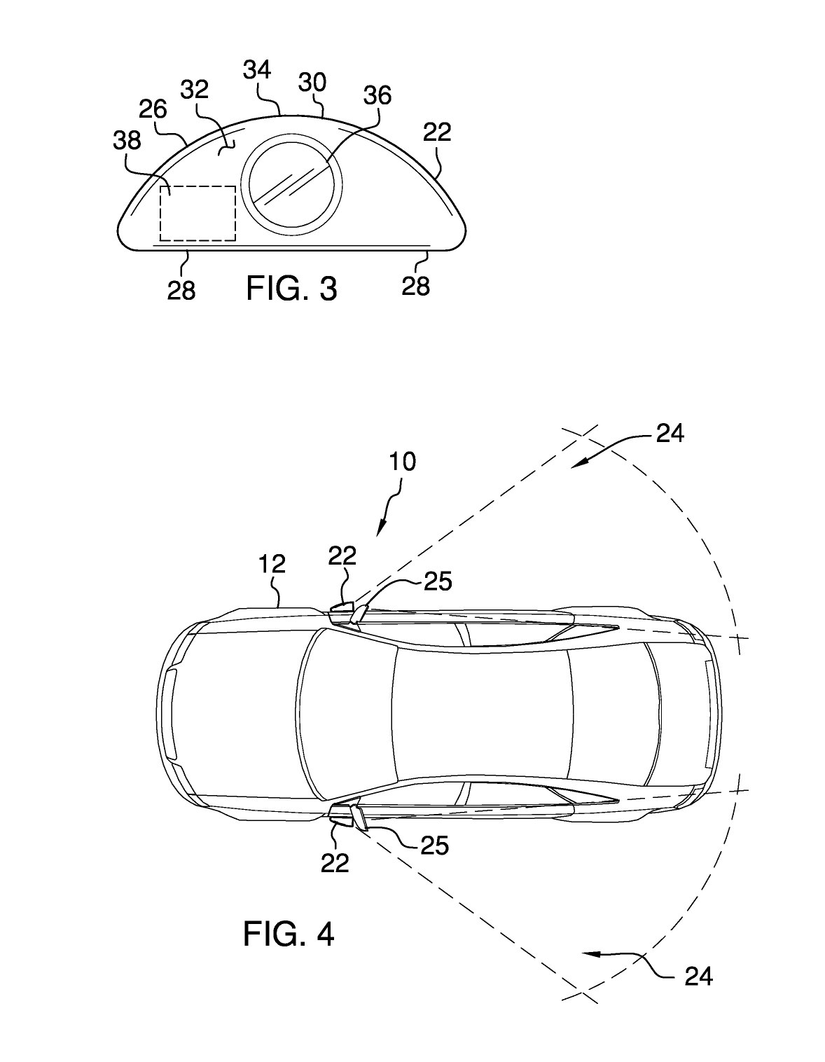

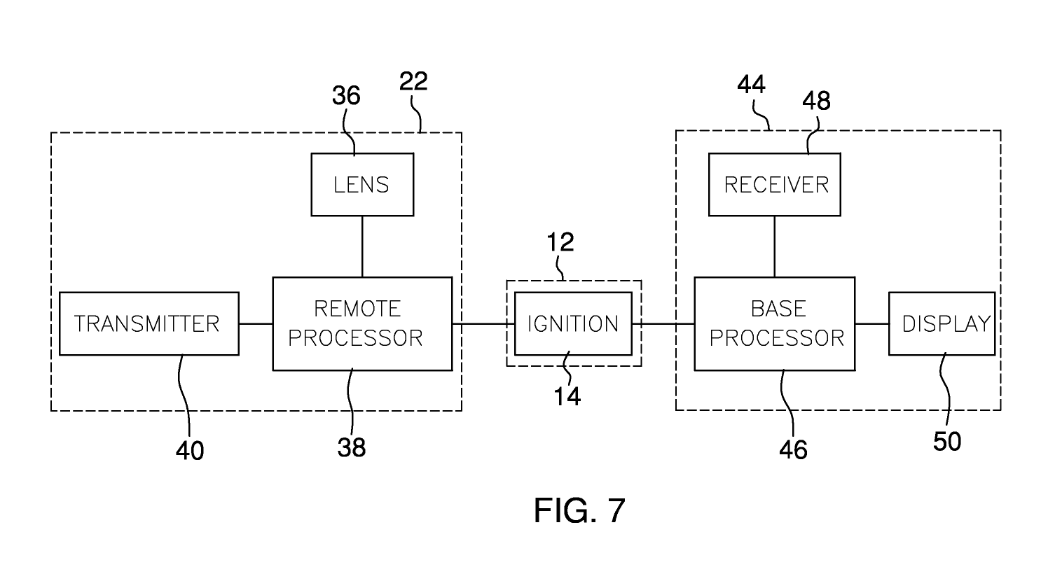

With reference now to the drawings, and in particular to FIGS. 1 through 7 thereof, a new camera device embodying the principles and concepts of an embodiment of the disclosure and generally designated by the reference numeral 10 will be described.

As best illustrated in FIGS. 1 through 7, the rear view camera system 10 generally comprises a vehicle 12 that has an ignition 14. The vehicle 12 has a first lateral side 16, a second lateral side 18 and a back side 20. The vehicle 12 may be a passenger vehicle or the like.

A pair of cameras 22 is provided and each of the cameras 22 is coupled to the vehicle 12. Each of the cameras 22 is positioned on an associated one of the first lateral side 16 and the second lateral side 18. Each of the cameras 22 is oriented to face the back side 20. Thus, each of the cameras 22 may monitor an associated one of a pair of blind spots 24 with respect to the vehicle 12. The vehicle may have a pair of rear view mirrors 25. Each of the cameras 22 may be aligned with an associated one of the rear view mirrors 25.

Each of the cameras 22 comprises a housing 26 that has a basal wall 28 and an outer wall 30. The outer wall 30 has a front surface 32 and a top surface 34. The top surface 34 is continuous such that the top surface 34 forms a dome-like shape with respect to the basal wall 28. Thus, the housing 26 has an aerodynamic profile. The front surface 32 is flattened and the housing 26 tapers longitudinally with respect to the front surface 32. The basal wall 28 is removably coupled to the vehicle 12 such that the front surface 32 faces the back side 20 of the vehicle 12.

A lens 36 is coupled to the front surface 32. Thus, the lens 36 may monitor the associated blind spot 24. A remote processor 38 is positioned within the housing 26 and the lens 36 is electrically coupled to the remote processor 38. The lens 36 may comprise a digital video lens or the like and the lens 36 sends images to the remote processor 38. The remote processor 38 is electrically coupled to the ignition 14 such that the ignition 14 turns the remote processor 38 on and off. The remote processor 38 may comprise an electronic processor or the like.

A transmitter 40 is positioned within the housing 26 and the transmitter 40 is electrically coupled to the remote processor 38. The transmitter 40 may comprise a radio frequency transmitter or the like. The transmitter 40 may utilize a WPAN signal.

A pair of couplers 42 is provided and each of the couplers 42 is coupled to the basal wall 28. Each of the couplers 42 removably engages the vehicle 12 such that the housing 26 is retained on the vehicle 12. Each of the couplers 42 may comprise a magnet. Thus, each of the couplers 42 may magnetically engage the vehicle 12.

A monitor 44 is positioned within the vehicle 12. The monitor 44 may be observed while the vehicle 12 is driven. The monitor 44 is in communication with each of the cameras 22 and the monitor 44 displays each of the pair of blind spots 24. Thus, the monitor 44 and the cameras 22 enhance safe operation of the vehicle 12.

The monitor 44 comprises a base processor 46 that is positioned within the monitor 44. The base processor 46 is electrically coupled to the ignition 14 such that the ignition 14 turns the base processor 46 on and off. The base processor 46 may comprise an electronic processor or the like. A receiver 48 is positioned within the monitor 44 and the receiver 48 is electrically coupled to the base processor 46. The receiver 48 is in electrical communication with the transmitter 40. The receiver 48 may comprise a radio frequency receiver or the like and the receiver 48 may utilize a WPAN signal.

A display 50 is coupled to the monitor 44 and the display 50 may be viewed. The display 50 is electrically coupled to the base processor 46. Thus, the display 50 may display images captured by each of the cameras 22. The display 50 may comprise an LED or the like. The vehicle 12 may be manufactured with each of the cameras 22 replacing the associated rear view mirror 25. The aerodynamic profile of each of the cameras 22 reduces drag with respect to the rear view mirrors 25. Thus, the fuel efficiency of the vehicle 12 is increased.

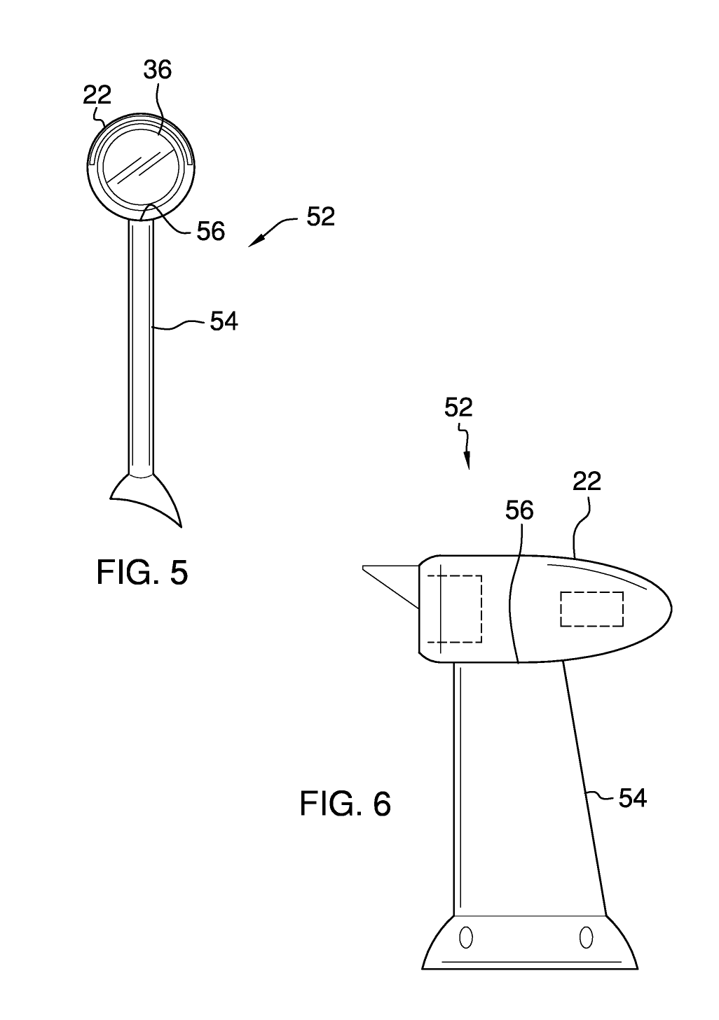

In an alternative embodiment 52 as shown in FIGS. 5 and 6, each of the cameras 22 may include a mount 54. The mount 54 may be coupled to the vehicle 12 and the mount 54 may extend laterally away from the vehicle 12. The mount 54 has a distal end 56 with respect to the vehicle 12 and the lens 36 is positioned on the distal end 56. Thus, the lens 36 is spaced from the vehicle 12 thereby enhancing visibility of the associated blind spot 24.

In use, each of the cameras 22 and the monitor 44 are turned on when the ignition 14 is turned on. The transmitter 40 in each camera 22 transmits the images to the receiver 48 and the display 50 displays the images. The cameras 22 and the display 50 enhance visibility of the blind spots 24. Thus, the vehicle 12 is operated without striking adjacent vehicles positioned in one of the blind spots 24.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A rear view camera system comprising:
a vehicle having an ignition, said vehicle having a first lateral side, a second lateral side and a back side;
a pair of cameras, each of said cameras being coupled to said vehicle, each of said cameras being positioned on an associated one of said first lateral side and said second lateral side, each of said cameras being oriented to face said back side wherein each of said cameras is configured to monitor an associated one of a pair of blind spots with respect to said vehicle; and
a monitor being positioned within said vehicle wherein said monitor is configured to be observed while said vehicle is being driven, said monitor being in communication with each of said cameras wherein said monitor is configured to display each of the pair of blind spots thereby enhancing safe operation of said vehicle.

2. The system according to claim 1, wherein each of said cameras comprises a housing having a basal wall and an outer wall, said outer wall having a front surface and a top surface, said top surface being curved such that said top surface forms a dome with respect to said basal wall wherein said housing is configured to have an aerodynamic profile, said front surface being flattened, said basal wall being removably coupled to said vehicle such that said front surface faces said back side of said vehicle.

3. The system according to claim 2, further comprising a lens being coupled to said front surface wherein said lens is configured to monitor the associated blind spot.

4. The system according to claim 3, further comprising:
a remote processor being positioned within said housing, said lens being electrically coupled to said remote processor, said remote processor being electrically coupled to said ignition such that said ignition turns said remote processor on and off; and
a transmitter being positioned within said housing, said transmitter being electrically coupled to said remote processor.

5. The system according to claim 4, further comprising a pair of couplers, each of said couplers being coupled to said basal wall, each of said couplers removably engaging said vehicle such that said housing is retained on said vehicle.

6. The system according to claim 1, wherein said monitor comprises:
a base processor being positioned within said monitor, said base processor being electrically coupled to said ignition such that said ignition turns said base processor on and off; and
a receiver being positioned within said monitor, said receiver being electrically coupled to said base processor, said receiver being in electrical communication with said transmitter.

7. The system according to claim 6, further comprising a display being coupled to said monitor wherein said display is configured to be viewed, said display being electrically coupled to said base processor wherein said display is configured to display images captured by each of said cameras.

8. A rear view camera system comprising:
a vehicle having an ignition, said vehicle having a first lateral side, a second lateral side and a back side;
a pair of cameras, each of said cameras being coupled to said vehicle, each of said cameras being positioned on an associated one of said first lateral side and said second lateral side, each of said cameras being oriented to face said back side wherein each of said cameras is configured to monitor an associated one of a pair of blind spots with respect to said vehicle, each of said cameras comprising:
a housing having a basal wall and an outer wall, said outer wall having a front surface and a top surface, said top surface being continuous such that said top surface forms a dome with respect to said basal wall wherein said housing is configured to have an aerodynamic profile, said front surface being flattened, said basal wall being removably coupled to said vehicle such that said front surface faces said back side,
a lens being coupled to said front surface wherein said lens is configured to monitor the associated blind spot,
a remote processor being positioned within said housing, said lens being electrically coupled to said remote processor, said remote processor being electrically coupled to said ignition such that said ignition turns said remote processor on and off,
a transmitter being positioned within said housing, said transmitter being electrically coupled to said remote processor, and
a pair of couplers, each of said couplers being coupled to said basal wall, each of said couplers removably engaging said vehicle such that said housing is retained on said vehicle; and
a monitor being positioned within said vehicle wherein said monitor is configured to be observed while said vehicle is being driven, said monitor being in communication with each of said cameras wherein said monitor is configured to display each of the pair of blind spots thereby enhancing safe operation of said vehicle, said monitor comprising:
a base processor being positioned within said monitor, said base processor being electrically coupled to said ignition such that said ignition turns said base processor on and off,
a receiver being positioned within said monitor, said receiver being electrically coupled to said base processor, said receiver being in electrical communication with said transmitter, and
a display being coupled to said monitor wherein said display is configured to be viewed, said display being electrically coupled to said base processor wherein said display is configured to display images captured by each of said cameras.
